(19) United States
(12) Patent Application Publication
(10) Pub. No.: US 2009/0317202 A1
(43) Pub. Date: Dec. 24, 2009

(54) STRONG HIGH PERFORMANCE TWIST DRILL

(75) Inventor: Xiaokun Zhu, Jiangsu (CN)

Correspondence Address: SCHMEISER, OLSEN & WATTS, 22 CENTURY HILL DRIVE, SUITE 302, LATHAM, NY, 12110, US

(73) Assignee: JIANGSU TIANGONG TOOLS CO., LTD., DANYANG CITY, JIANGSU 212300 (CN)

(21) Appl. No.: 12/303,268

(22) PCT Filed: Jun. 9, 2006
(86) PCT No.: PCT/CN2006/001276

§ 371 Date: Dec. 3, 2008

(51) Int. Cl. B23B 51/02

(52) U.S. Cl. 408/230

(57) ABSTRACT

A strong high performance twist drill which aims at providing a high performance twist drill to solve the existing problems effectively. The twist drill can reduce the change in value of the rake angle, increase the value of the rake angle especially at the position approaching the drill core, and improve the cutting condition. The twist drill comprises a shank and a working part. Said working part comprises a cutting part and a guiding part. Said cutting part includes a rake face, a relief face, a main cutting edge and a chisel edge; said guiding part includes rear groove edges and flutes; wherein, said main cutting edge tilts towards the drill core from outside to inside; the angle between the main cutting edge and the center vertical line at the cross section is in the range of 3-25°; said main cutting edge intersects with back groove face at the narrow chisel edge; the length of the narrow chisel edge is in the range of 0.03-0.5 mm; and the rake angle at the drill core is positive.

### TECHNICAL FIELD

This utility model relates to a type of hole processing tool, in particular a type of twist drill.

### BACKGROUND OF INVENTION

As shown in FIG. 1, the twist drill is the most widely used hole processing tool. Normally, diameter range is 0.25˜80 mm. A twist drill mainly consists of a working part and a shank. The working part includes two spiral grooves. Helix angle of twist drill mainly affects rake angle on cutting edge, strength of edge clack, and chip removal performance, and is normally 25°˜32°. Spiral grooves can be processed by milling, grinding, hot rolling, or hot extrusion etc. After tool grinding, front end of drill becomes cutting part. Vertex angle of cutting part of standard twist drill is 118°. Chisel edge angle is 40°˜60°. Angle of relief is 8°˜20°. Due to structural causes, rake angle is large at outer part and gradually decrease toward middle part. At chisel edge, rake angle is negative (can reach about −55°). During drilling, chisel edge functions as extrusion effect.

During drilling, a twist drill has two main cutting edges and one chisel edge that cut (FIG. 2), often referred to as “one bit (drill core bit) and three edges”. Twist drill operates in semi-enclosed status with chisel edge seriously squeezed and chip removal not free. Therefore, processing conditions are more complicated and difficult than those of turning and other cutting methods. In addition, processing precision is relatively low and surface processed is relatively rough. Quality and efficiency of drilling largely depend on shape of drill cutting edge. During production, the method of grinding is often used to change shape and angel of twist drill cutting edge to reduce cutting resistance and improve drilling performance. Twist drill shank can be straight or conical. During processing, the former will be clamped in drill chuck, while the latter will be inserted in the conical hole in lathe main shaft or tailstock.

Traditional normal twist drill has the following main problems:
1. Value of rake angle on each point of main cutting edge varies greatly and becomes negative where approaching drill core; hence cutting conditions are poor.
2. Chisel edge is too long and cutting edge angle is very large. With very negative rake angle, cutting conditions are even poorer. Therefore, axial resistance is large and centering is poor.
3. Main cutting edge is long and cutting is wide, so that chips coil to wide spiral roll, occupying large space and making chip removal not free (it is difficult for cutting liquid to flow in).

To improve performance of traditional twist drills, many methods have been adopted. Chip dividing groove or grinding of outer edge and chisel edge has been adopted, greatly improving twist drill performance. However, variation of rake angle on each point of main cutting edge is still large, and negative rake angle still exists near drill core. Poor cutting conditions have not been essentially changed.

### SUMMARY OF THE INVENTION

To effectively solve these problems, this utility model provides a type of strong high performance twist drill, so that change of rake angle on main cutting edge is small and rake angle values are increased. In particular, value of rake angle near drill core is increased, improving cutting conditions.

To achieve above purposes, this utility model adopts the following technical scheme: A type of strong high performance twist drill, comprising a shank and a working part. Said working part comprises a cutting part and a guiding part. Said cutting part includes a rake face, a relief face, main cutting edge, and chisel edge. Said guiding part includes rear groove edge and flute. Wherein said main cutting edge tilts towards drill core from outside to inside. In the cross section, angle between main cutting edge and center vertical line is 3-25°. Main cutting edge intersects with back groove face at narrow chisel edge. Length of narrow chisel edge is 0.03-0.5 mm. Rake angle at drill core is positive.

Length of aforesaid chisel edge shall be determined according to product size, and is normally 0.03 mm-0.5 mm.

In this utility model, through grinding of rake face and main cutting edge of traditional normal twist drill, main cutting edge tilts towards drill core so that chisel edge is shortened. At the same time, change of rake angle on main cutting edge is smaller and rake angle at drill core is positive. Above improvement reduces drilling resistance so that axial force of this utility model is lower than that of normal twist drill by about 30% and its torque lower than that of normal twist drill by about 15%. Above processing is symmetric processing.

As further improvement of this utility model, crescent shaped arc groove is provided on relief face near dill core. On left and right straight edges of the main cutting edge, outer edge, concave edge and inner edge are provided from outside to inside. Included angle of outer edge generating line is larger than that of inner edge generating line by 5-20°. Radius of concave edge shall be determined according to diameter of twist drill, and is normally set to 0.2-0.8 mm. Angle of relief is 12°-18°.

Above improvement is to grind relief face to generate two symmetric crescent shaped arc grooves, and form the shape of 3 apices and 7 edges (“ [symbol] ”), thus reducing drilling heat, temperature of cutting edge, and wear of cutting edge, improving durability of drill, and increasing production efficiency by 3-5 times.

As further improvement of this utility model, transition edge at intersection between main cutting edge rear groove edge and small outer arc face adopts round angle.

Above improvement is to grind rear groove edge to remove closed angle and form round angle, so that chips are evenly distributed along main cutting edge, have small deform, are basically in the form of strips, and can be discharged easily along flutes.

As further improvement of this utility model, groove shaped angle formed by main cutting edge and back groove face is an open V in the section perpendicular to drill edge helix.

Above improvement is to grind back groove edge to increase groove shaped angle and drill core thickness, thereby increasing drill strength against twisting.

### DESCRIPTION OF DRAWINGS

FIG. 1 is structural schematic of traditional twist drill.

FIG. 2 is structural schematic of apex of traditional twist drill.

FIG. 3 is front view of cutting part of preferred embodiments 1-3 of this utility model.

FIG. 4 is structural schematic of main cutting edge and rake face of this utility model 1-3.

FIG. 5 is structural schematic of main cutting edge and relief face of this utility model 4-6.

FIG. 6 is axial structural schematic of this utility model 1-3.

FIG. 7 is A-A section view of FIG. 6.

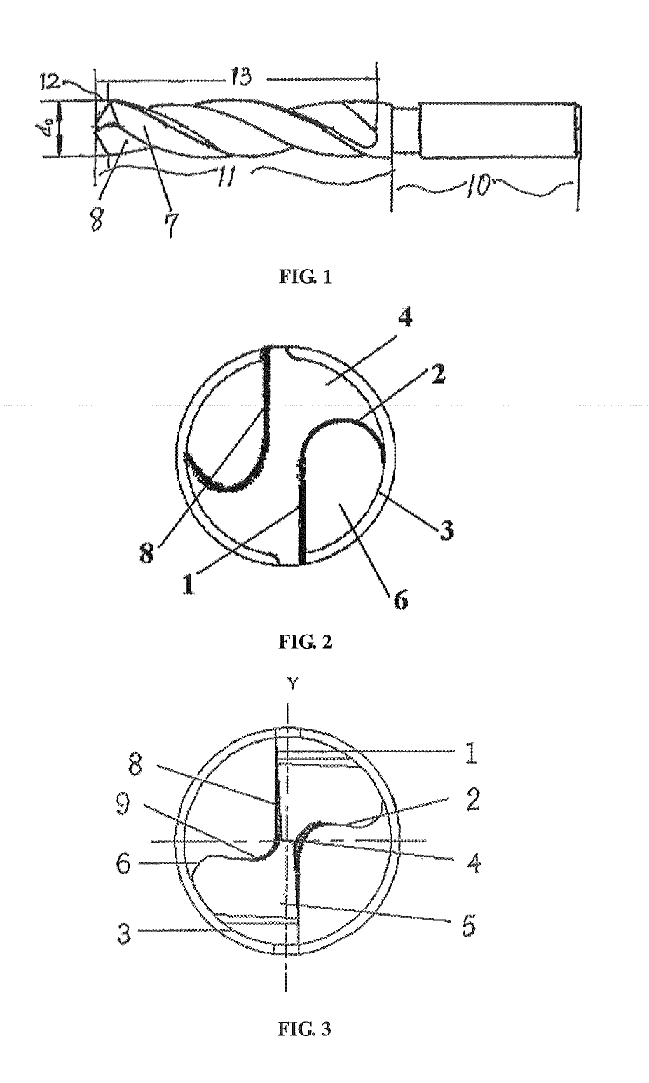

In above figures,
1: Main cutting edge;
2: Rear groove edge;
3: Small outer arc face;
4: Chisel edge;
5: Relief face;
6: Back groove edge;
7: Chip dividing groove;
8: Rake face;
9: Back groove face;
10: Shank;
11: Working part;
12: Cutting part;
13: Guiding part;
16: Crescent shaped arc groove;
17: Outer edge;
18: Concave edge;
19: Inner edge.

### PREFERRED EMBODIMENTS

The following further describes this utility model in combination with the figures.

### Preferred Embodiment 1

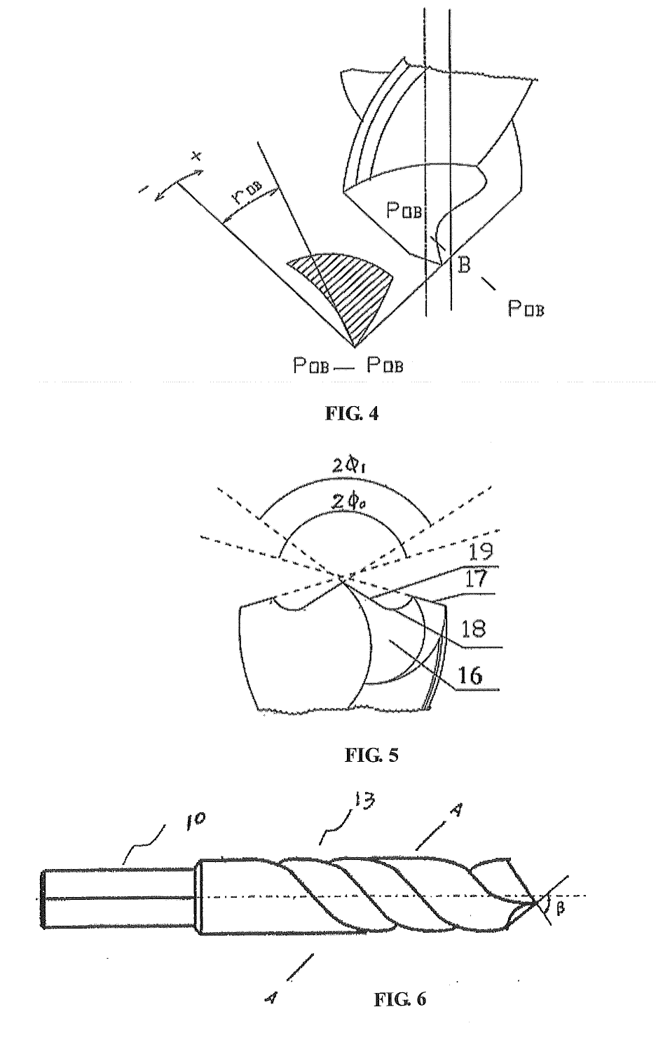

As shown in FIG. 3 and FIG. 4, a strong high performance twist drill of diameter of 0.25 mm, comprising shank 10 and working part 11. Said working part comprising cutting part 12 and guiding part 13. Said cutting part 12 consists of rake face 8, relief face 5, main cutting edge 1 and chisel edge 4. Said guiding part 13 consists of rear groove edge 2 and chip dividing groove 7. Main cutting edge tilts towards drill core from outside to inside. In cross section, included angle between main cutting edge 1 and center vertical line Y is 3°. Main cutting edge 1 and rear groove edge 2 intersects at narrow chisel edge 4. Length of narrow chisel edge is 0.03 mm. Rake angle at drill core is positive.

As shown in FIG. 3, transition edge at intersection between rear groove edge 2 and small outer arc face 3 is round angle.

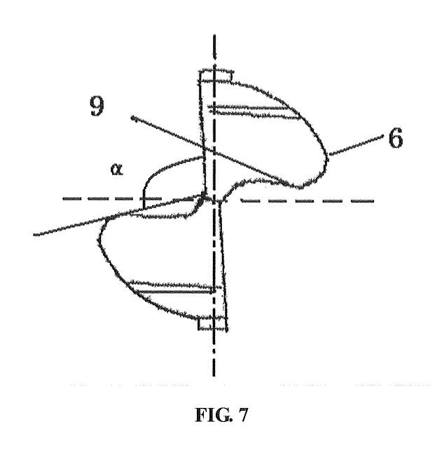

As shown in FIG. 6 and FIG. 7, groove shaped angle formed by main cutting edge 1 and back groove face 9 is an open V on cross section perpendicular to drill edge helix. The angle of helix of drill edge helix is 25°. Vertex angle β is 110°. Groove shaped angle α in this cross section will be 100°.

As shown in FIG. 6, shank 10 includes 3 planes at 60° with one another. Cross section formed by these 3 planes is an equilateral triangle, the center of which coincides with drill axis line. Therefore, clamping of drill is easy, firm, and not easily loosened, and cutting efficiency has been further improved.

### Preferred Embodiment 2

As shown in FIG. 3 and FIG. 4, a strong high performance twist drill of diameter of 30 mm, comprising shank 10 and working part 11. Said working part comprising cutting part 12 and guiding part 13. Said cutting part 12 consists of rake face 8, relief face 5, main cutting edge 1, and chisel edge 4. Said guiding part 13 consists of rear groove edge 2 and chip dividing groove 7. Main cutting edge tilts towards drill core from outside to inside. In cross section, included angle between main cutting edge 1 and center vertical line Y is 15°. Main cutting edge 1 and rear groove edge 2 intersects at narrow chisel edge 4. Length of narrow chisel edge is 0.25 mm. Rake angle at drill core is positive.

As shown in FIG. 3, transition edge at intersection between rear groove edge 2 and small outer arc face 3 is round angle.

As shown in FIG. 6 and FIG. 7, groove shaped angle formed by main cutting edge 1 and back groove face 9 is an open V on cross section perpendicular to drill edge helix. The angle of helix of drill edge helix is 30°. Vertex angle β is 120°. Groove shaped angle α in this cross section will be 125°.

As shown in FIG. 6, shank 10 includes 3 planes at 60° with one another. Cross section formed by these 3 planes is an equilateral triangle, the center of which coincides with drill axis line. Therefore, clamping of drill is easy, firm, and not easily loosened, and cutting efficiency has been further improved.

### Preferred Embodiment 3

As shown in FIG. 3 and FIG. 4, a strong high performance twist drill of diameter of 80 mm, comprising shank 10 and working part 11. Said working part comprising cutting part 12 and guiding part 13. Said cutting part 12 consists of rake face 8, relief face 5, main cutting edge 1, and chisel edge 4. Said guiding part 13 consists of rear groove edge 2 and chip dividing groove 7. Main cutting edge tilts towards drill core from outside to inside. In cross section, included angle between main cutting edge 1 and center vertical line Y is 25°. Main cutting edge 1 and rear groove edge 2 intersects at narrow chisel edge 4. Length of narrow chisel edge is 0.5 mm. Rake angle at drill core is positive.

As shown in FIG. 3, transition edge at intersection between rear groove edge 2 and small outer arc face 3 is round angle.

As shown in FIG. 6 and FIG. 7, groove shaped angle formed by main cutting edge 1 and back groove face 9 is an open V on cross section perpendicular to drill edge helix. The angle of helix of drill edge helix is 35°. Vertex angle β is 140°. Groove shaped angle α in this cross section will be 150°.

As shown in FIG. 6, shank 10 includes 3 planes at 60° with one another. Cross section formed by these 3 planes is an equilateral triangle, the center of which coincides with drill axis line. Therefore, clamping of drill is easy, firm, and not easily loosened, and cutting efficiency has been further improved.

### Preferred Embodiment 4

This preferred embodiment is basically the same as preferred embodiment 1. Differences lie in: As shown in FIG. 5, on relief face 5 near drill core, crescent shaped arc groove 16 is provided, and on left and right straight edge of main cutting edge, outer edge 17, concave edge 18 and inner edge 19 are provided from outside to inside. Outer edge generating line included angle 2Φ₀ is larger than inner edge generating line included angle 2Φ₁ by 5°, that is to say, 2Φ₀ is 110°<2Φ₀≦140° (e.g.: 112°, 118°, 125°, 135°, 140°) and 2Φ₁ is 107°<2Φ₀≦135° (e.g. 107°, 113°, 120°, 130°, 135°). Concave edge 18 has a radius of 0.2 mm and angle of relief of 12°.

### Preferred Embodiment 5

This preferred embodiment is basically the same as preferred embodiment 2. Differences lie in: As shown in FIG. 5, on relief face 5 near drill core, crescent shaped arc groove 16 is provided, and on left and right straight edge of main cutting edge, outer edge 17, concave edge 18 and inner edge 19 are provided from outside to inside. Outer edge generating line included angle 2Φ₀ is larger than inner edge generating line included angle 2Φ₁ by 15°, that is to say, 2Φ₀ is 110°<2Φ₀≦140° (e.g.: 112°, 118°, 125°, 135°, 140°) and 2Φ₁ is 95°<2Φ₀≦125° (e.g. 97°, 103°, 110°, 120°, 125°). Concave edge 18 has a radius of 0.5 mm and angle of relief of 16°.

### Preferred Embodiment 6

This preferred embodiment is basically the same as preferred embodiment 3. Differences lie in: As shown in FIG. 5, on relief face 5 near drill core, crescent shaped arc groove 16 is provided, and on left and right straight edge of main cutting edge, outer edge 17, concave edge 18 and inner edge 19 are provided from outside to inside. Outer edge generating line included angle 2Φ₀ is larger than inner edge generating line included angle 2Φ₁ by 20°, that is to say, 2Φ₀ is 110°<2Φ₀≦140° (e.g.: 112°, 118°, 125°, 135°, 140°) and 2Φ₁ is 90°<2Φ₀≦120° (e.g. 92°, 98°, 105°, 115°, 120°). Concave edge 18 has a radius of 0.8 mm and angle of relief of 18°.

What is claimed is:

1. A type of strong high performance twist drill comprising a shank and a working part; said working part comprising a cutting part and a guiding part; said cutting part consisting of a rake face, a relief face, a main cutting edge and a chisel edge, and said guiding part consisting of rear groove edges and flutes; wherein said main cutting edge tilts towards drill core from outside to inside, the angle between the main cutting edge and the center vertical line at the cross section is in the range of 3-25°, said main cutting edge intersects with back groove face at the narrow chisel edge; the length of the narrow chisel edge is in the range of 0.03-0.5 mm; and the rake angle at the drill core is positive.

2. The twist drill of claim 1 wherein crescent shaped arc groove is provided on relief face near drill core, outer edge, concave edge and inner edge are provided on left and right straight edge of the main cutting edge from outside to inside, and outer edge generating line included angle is larger than inner edge generating line included angle by 5-20°.

3. The twist drill of claim 1 wherein transition edge at intersection between said main cutting edge rear groove edge and nearby small outer arc face is a round angle.

4. The twist drill of claim 1 wherein groove shaped angle formed by said main cutting edge and back groove face is an open V on cross section perpendicular to drill edge helix.

5. The twist drill of claim 1 wherein said shank is provided with 3 planes.

6. The twist drill of claim 2 wherein included angle of said outer edge generating line is 110°<2Φ0≦140°, radius of said concave edge is 0.2-0.8 mm, and angle of relief of said concave edge is 12°-18°.

7. The twist drill of claim 4 wherein said groove shaped angle on said cross section α is 100°-150°.

8. The twist drill of claim 5 wherein the 3 planes on said shank is at 60° with one another, and cross section formed by these planes is an equilateral triangle, the center of which coincides with drill axis line.
